(19) United States
(12) Patent Application Publication
(10) Pub. No.: US 2022/0042922 A1
(43) Pub. Date: Feb. 10, 2022

(54) Inspection Compliance Validation System

(71) Applicant: Brian Smiley, Birmingham, AL (US)

(72) Inventor: Brian Smiley, Birmingham, AL (US)

(21) Appl. No.: 16/986,723

(22) Filed: Aug. 6, 2020

(51) Int. Cl. G01N 21/88; G06F 1/3212; G06F 13/38; G06F 1/16

(52) U.S. Cl. CPC G01N 21/8806; G06F 1/3212; G06F 2213/0042; G06F 1/1607; G06F 13/382

(57) ABSTRACT

An inspection compliance validation system for a truck includes a plurality of indicators and a reader. Each indicator is coupled to a vehicle proximate to a respective inspection site of the vehicle and is operationally coupled to an electronic logging device of the vehicle. The electronic logging device is positioned to selectively actuate the indicator to notify a user of an inspection status for an associated inspection site. The reader is configured to receive a signal from a respective indicator corresponding to the inspection status of the associated inspection site and to relay the signal to the electronic logging device to validate that an inspection has been performed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98.

The disclosure and prior art relate to validation systems and more particularly pertains to a new validation system for a truck.

### BRIEF SUMMARY OF THE INVENTION

An embodiment of the disclosure meets the needs presented above by generally comprising a plurality of indicators and a reader. Each indicator is coupled to a vehicle proximate to a respective inspection site of the vehicle and is operationally coupled to an electronic logging device of the vehicle. The electronic logging device is positioned to selectively actuate the indicator to notify a user of an inspection status for an associated inspection site. The reader is configured to receive a signal from a respective indicator corresponding to the inspection status of the associated inspection site and to relay the signal to the electronic logging device to validate that an inspection has been performed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an inspection compliance validation system according to an embodiment of the disclosure.

FIG. 2 is a block diagram of an embodiment of the disclosure.

FIG. 3 is an in-use view of an embodiment of the disclosure.

### DETAILED DESCRIPTION OF THE INVENTION

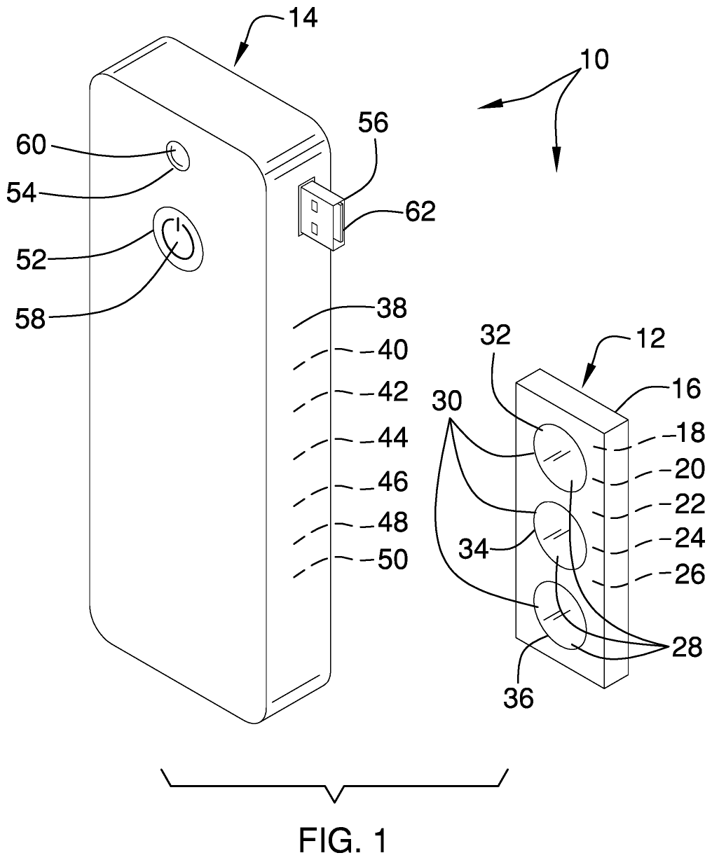

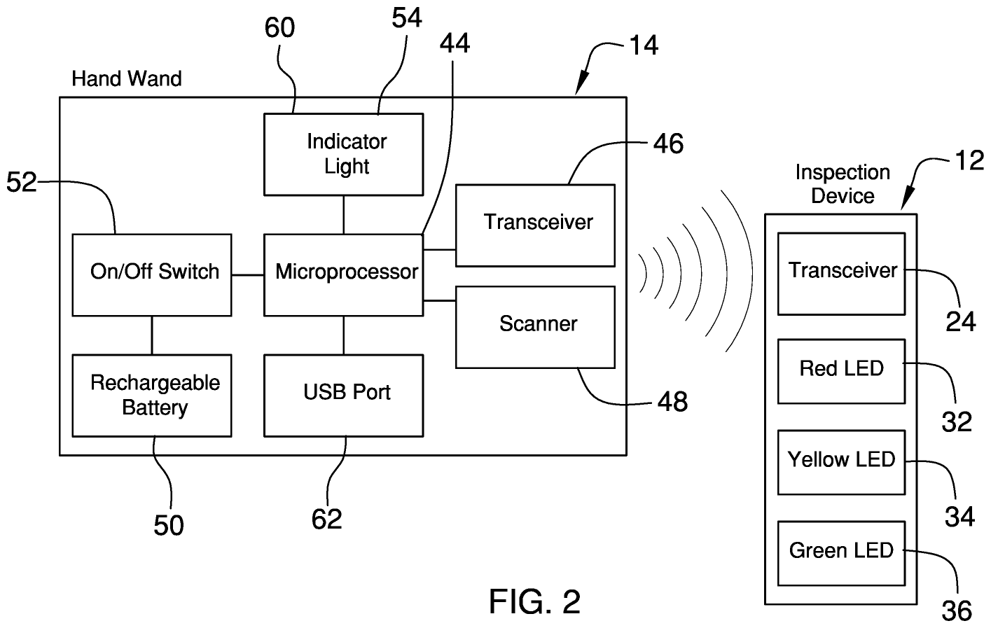

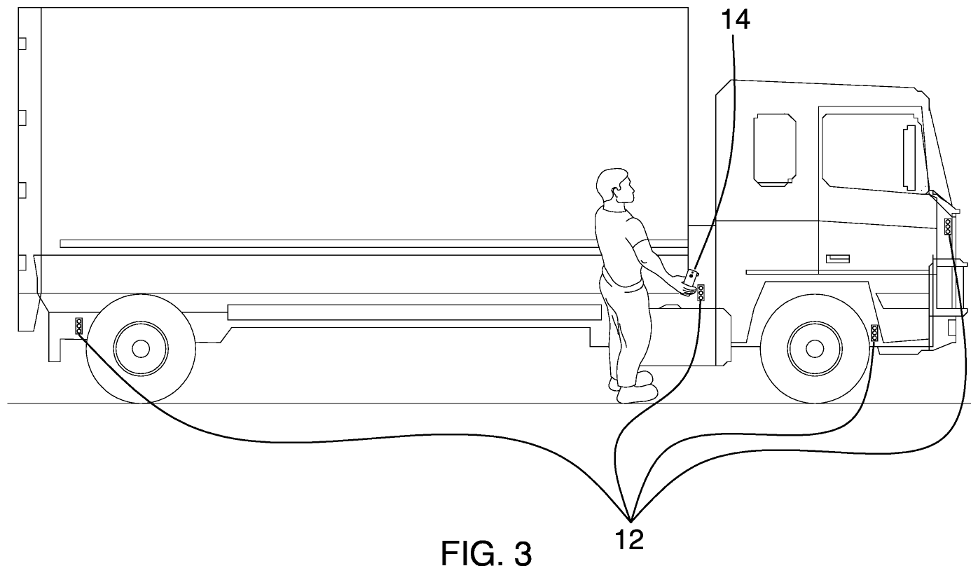

With reference now to the drawings, and in particular to FIGS. 1 through 3 thereof, a new validation system embodying the principles and concepts of an embodiment of the disclosure and generally designated by the reference numeral 10 will be described.

As best illustrated in FIGS. 1 through 3, the inspection compliance validation system 10 generally comprises a plurality of indicators 12 and a reader 14. Each indicator 12 is coupled to a vehicle, such as a semitruck and trailer, proximate to a respective inspection site of the vehicle and is operationally coupled to an electronic logging device of the vehicle. The electronic logging device is positioned to selectively actuate the indicator 12 to notify a user of an inspection status for an associated inspection site.

It is anticipated that the plurality of indicators 12 will be coupled to the vehicle by methods well known to those skilled in the art of coupling indicators to vehicles. A method that provides evidence of tampering is preferred.

Each indicator 12 comprises a first housing 16 that defines an internal space 18. A first power module 20, a first microprocessor 22, and a first transceiver 24 are coupled to the first housing 16 and are positioned in the internal space 18. The first power module 20 comprises a first battery 26. The first microprocessor 22 is operationally coupled to the first power module 20 and the first transceiver 24.

A barometer 28 that is coupled to the first housing 16 is operationally coupled to the first microprocessor 22. The first transceiver 24 is configured to receive a signal that identifies the inspection status of the associated inspection site from the electronic logging system and to relay the signal to the first microprocessor 22 so that the first microprocessor 22 is positioned to selectively actuate the barometer 28 to notify the user of the inspection status for the associated inspection site.

The barometer 28 comprises a set of three bulbs 30. Each bulb 30 is configured to emit a respective color of light so that the set of three bulbs 30 is configured to selectively emit three colors of light. Each color corresponds to an associated inspection status.

The set of three bulbs 30 comprises a red light emitting diode 32, a yellow light emitting diode 34, and a green light emitting diode 36. The first microprocessor 22 is positioned to actuate the red light emitting diode 32 when an inspection is required, the yellow light emitting diode 34 when inspection is ongoing, and the green light emitting diode 36 when inspection has been completed. The first microprocessor 22 is positioned to intermittently actuate the yellow light emitting diode 34 when the inspection is ongoing so that the yellow light emitting diode 34 blinks.

The reader 14 is configured to receive a signal from a respective indicator 12 corresponding to the inspection status of the associated inspection site and to relay the signal to the electronic logging device to validate that an inspection has been performed. Inspections of semitrucks are required by many jurisdictions, and the system 10 provides a means for the user to validate that the inspection has been performed.

The reader 14 comprises a second housing 38 that defines an interior space 40. A second power module 42, a second microprocessor 44, a second transceiver 46, and a detector 48 are coupled to the second housing 38 and are positioned in the interior space 40. The second power module 42 comprises a second battery 50. The second microprocessor 44 is operationally coupled to the second power module 42, the second transceiver 46, the detector 48.

A switch 52, an indicating bulb 54, and a connector 56 are coupled to the second housing 38 and operationally coupled to the second microprocessor 44. The switch 52 also is operationally coupled to the second power module 42 so that the switch 52 is positioned to selectively couple the second power module 42 to the second microprocessor 44 to power the reader 14.

The switch 52 comprises a button 58 that is depressible. The button 58 is configured to be depressed a first time to couple the second power module 42 to the second microprocessor 44 and to be depressed a second time to decouple the second power module 42 from the second microprocessor 44.

The detector 48 is configured to determine a proximity of the second transceiver 46 to the first transceiver 24 of the respective indicator 12 so that the second microprocessor 44 is positioned to determine a position of the user during the inspection. As the user must be present at the inspection site, the detector 48 provides a means of validating that the user was at the inspection site for a predetermined period of time.

The second microprocessor 44 is positioned to selectively actuate the indicating bulb 54 to notify the user that inspections are required and to deactivate the indicating bulb 54 when all of the inspections are completed. The indicating bulb 54 comprises a light emitting diode 60.

The connector 56 is configured to operationally couple the reader 14 to the electronic logging device to selectively charge the second battery 50 and to selectively transfer inspection status for each inspection site to the electronic logging device. The connector 56 comprises a Universal Serial Bus plug 62.

In use, when the vehicle is started, or an inspection is otherwise required, the electronic logging device will signal the reader 14 and the plurality of indicators 12 so that the light emitting diode of the reader 14 and the red light emitting diodes 32 of the indicators 12 are illuminated. As the user inspects each inspection site with the reader 14 in hand, the red light emitting diode 32 of an associated indicator 12 will deactivate and the yellow light emitting diode 34 will blink. After the required inspection time has elapsed, the yellow light emitting diode 34 will deactivate and the green light emitting diode 36 will be activated. The user then will proceed to the next inspection site until all inspection sites have been inspected and all the indicators 12 have an activated green light emitting diode 36. The inspection status for each inspection site is relayed from the reader 14 to the electronic logging device via the second transceiver 46, or manually by connecting the reader 14 to the electronic logging device using the Universal Serial Bus plug, which also serves to charge the second battery 50.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An inspection compliance validation system comprising:
a plurality of indicators, each indicator being coupled to a vehicle proximate to a respective inspection site of the vehicle, each indicator being operationally coupled to an electronic logging device of the vehicle wherein the electronic logging device is positioned for selectively actuating the indicator for notifying a user of an inspection status for an associated inspection site; and
a reader configured for receiving a signal from a respective indicator corresponding to the inspection status of the associated inspection site and for relaying the signal to the electronic logging device.

2. The system of claim 1, further including each indicator comprising:
a first housing defining an internal space;
a first power module coupled to the first housing and positioned in the internal space;
a first microprocessor coupled to the first housing and positioned in the internal space, the first microprocessor being operationally coupled to the first power module;
a first transceiver coupled to the first housing and positioned in the internal space, the first transceiver being operationally coupled to the first microprocessor; and
a barometer coupled to the first housing, the barometer being operationally coupled to the first microprocessor wherein the first transceiver is configured for receiving a signal identifying the inspection status of the associated inspection site from the electronic logging system and relaying the signal to the first microprocessor such that the first microprocessor is positioned for selectively actuating the barometer for notifying the user of the inspection status for the associated inspection site.

3. The system of claim 2, further including the first power module comprising a first battery.

4. The system of claim 2, further including the barometer comprising a set of three bulbs, each bulb being configured for emitting a respective color of light such that the set of three bulbs is configured for selectively emitting three colors of light wherein each color corresponds to an associated inspection status.

5. The system of claim 4, further including the set of three bulbs comprising a red light emitting diode, a yellow light emitting diode, and a green light emitting diode wherein the first microprocessor is positioned for actuating the red light emitting diode when an inspection is required, the yellow light emitting diode when inspection is ongoing, and the green light emitting diode when inspection has been completed.

6. The system of claim 5, further including the first microprocessor being positioned for intermittently actuating the yellow light emitting diode when the inspection is ongoing such that the yellow light emitting diode blinks.

7. The system of claim 2, further including the reader comprising:
a second housing defining an interior space;
a second power module coupled to the second housing and positioned in the interior space;
a second microprocessor coupled to the second housing and positioned in the interior space, the second microprocessor being operationally coupled to the second power module;
a second transceiver coupled to the second housing and positioned in the interior space, the second transceiver being operationally coupled to the second microprocessor; and
a detector coupled to the second housing and positioned in the interior space, the detector being operationally coupled to the second microprocessor, the detector being configured for determining a proximity of the second transceiver to the first transceiver of the respective indicator such that the second microprocessor is positioned for determining a position of the user during the inspection.

8. The system of claim 7, further including the second power module comprising a second battery.

9. The system of claim 7, further including a switch coupled to the second housing, the switch being operationally coupled to the second power module and the second microprocessor wherein the switch is positioned for selectively coupling the second power module to the second microprocessor for powering the reader.

10. The system of claim 9, further including the switch comprising a button, the button being depressible wherein the button is configured for depressing a first time for coupling the second power module to the second microprocessor and for depressing a second time for decoupling the second power module from the second microprocessor.

11. The system of claim 7, further including an indicating bulb coupled to the second housing, the indicating bulb being operationally coupled to the second microprocessor such that the second microprocessor is positioned for selectively actuating the indicating bulb for notifying the user inspections are required and for deactivating the indicating bulb when all inspections are completed.

12. The system of claim 11, further including the indicating bulb comprising a light emitting diode.

13. The system of claim 7, further including a connector coupled to the second housing, the connector being operationally coupled to the second microprocessor wherein the connector is configured for operationally coupling the reader to the electronic logging device for selectively charging the second battery and for selectively transferring inspection status for each inspection site to the electronic logging device.

14. The system of claim 13, further including the connector comprising a Universal Serial Bus plug.

15. An inspection compliance validation system comprising:
a plurality of indicators, each indicator being coupled to a vehicle proximate to a respective inspection site of the vehicle, each indicator being operationally coupled to an electronic logging device of the vehicle wherein the electronic logging device is positioned for selectively actuating the indicator for notifying a user of an inspection status for an associated inspection site, each indicator comprising:
a first housing defining an internal space,
a first power module coupled to the first housing and positioned in the internal space, the first power module comprising a first battery,
a first microprocessor coupled to the first housing and positioned in the internal space, the first microprocessor being operationally coupled to the first power module,
a first transceiver coupled to the first housing and positioned in the internal space, the first transceiver being operationally coupled to the first microprocessor,
a barometer coupled to the first housing, the barometer being operationally coupled to the first microprocessor wherein the first transceiver is configured for receiving a signal identifying the inspection status of the associated inspection site from the electronic logging system and relaying the signal to the first microprocessor such that the first microprocessor is positioned for selectively actuating the barometer for notifying the user of the inspection status for the associated inspection site, the barometer comprising a set of three bulbs, each bulb being configured for emitting a respective color of light such that the set of three bulbs is configured for selectively emitting three colors of light wherein each color corresponds to an associated inspection status, the set of three bulbs comprising a red light emitting diode, a yellow light emitting diode, and a green light emitting diode wherein the first microprocessor is positioned for actuating the red light emitting diode when an inspection is required, the yellow light emitting diode when inspection is ongoing, and the green light emitting diode when inspection has been completed, the first microprocessor being positioned for intermittently actuating the yellow light emitting diode when the inspection is ongoing such that the yellow light emitting diode blinks; and
a reader configured for receiving a signal from a respective indicator corresponding to the inspection status of the associated inspection site and for relaying the signal to the electronic logging device, the reader comprising:
a second housing defining an interior space,
a second power module coupled to the second housing and positioned in the interior space, the second power module comprising a second battery,
a second microprocessor coupled to the second housing and positioned in the interior space, the second microprocessor being operationally coupled to the second power module,
a second transceiver coupled to the second housing and positioned in the interior space, the second transceiver being operationally coupled to the second microprocessor,
a switch coupled to the second housing, the switch being operationally coupled to the second power module and the second microprocessor wherein the switch is positioned for selectively coupling the second power module to the second microprocessor for powering the reader, the switch comprising a button, the button being depressible wherein the button is configured for depressing a first time for coupling the second power module to the second microprocessor and for depressing a second time for decoupling the second power module from the second microprocessor,
a detector coupled to the second housing and positioned in the interior space, the detector being operationally coupled to the second microprocessor, the detector being configured for determining a proximity of the second transceiver to the first transceiver of the respective indicator such that the second microprocessor is positioned for determining a position of the user during the inspection,
an indicating bulb coupled to the second housing, the indicating bulb being operationally coupled to the second microprocessor such that the second microprocessor is positioned for selectively actuating the indicating bulb for notifying the user inspections are required and for deactivating the indicating bulb when all inspections are completed, the indicating bulb comprising a light emitting diode, and
a connector coupled to the second housing, the connector being operationally coupled to the second microprocessor wherein the connector is configured for operationally coupling the reader to the electronic logging device for selectively charging the second battery and for selectively transferring inspection status for each inspection site to the electronic logging device, the connector comprising a Universal Serial Bus plug.
